(19) United States
(12) Patent Application Publication
(10) Pub. No.: US 2011/0087536 A1
(43) Pub. Date: Apr. 14, 2011

(54) SYSTEM AND METHOD FOR CAREER ASSISTANCE

(75) Inventors: Doreen Amorosa, Warren, NJ (US); Kerry Boorer, Jersey City, NJ (US); Walter K. Frye, New York, NY (US); Kathleen McCarthy, Norwalk, CT (US); Lawrence Sharnak, East Brunswick, NJ (US)

(73) Assignee: American Express Travel Related Services Company, Inc., New York, NY (US)

(21) Appl. No.: 12/884,606

(22) Filed: Sep. 17, 2010

Related U.S. Application Data
(60) Provisional application No. 61/249,909, filed on Oct. 8, 2009.

(51) Int. Cl. G06Q 40/00; G06Q 10/00

(52) U.S. Cl. 705/14.32; 705/320

(57) ABSTRACT

A system and method for offering services and benefits to transaction account holders desiring access to career assistance tools and related services is disclosed. The system may include identifying a qualifying transaction account, providing access to the career assistance program to a qualifying transaction account holder, and annotating the identified qualifying transaction account associated with the qualifying transaction account holder with an indicator of participation in the career assistance program. The identified qualifying transaction account may be determined to meet a predetermined criteria. The career assistance program may include career counseling and career placement advice.

### CROSS REFERENCE TO RELATED APPLICATIONS

This application claims priority to, and the benefit of, U.S. Provisional Ser. No. 61/249,909, filed on Oct. 8, 2009 and entitled “System and Method for Career Assistance,” the entire contents of which is hereby incorporated by reference.

### FIELD OF THE INVENTION

The present disclosure relates generally to facilitating communication and/or career assistance, and more particularly, to a system and method for offering services and benefits to transaction account holders in need of career assistance tools and related services.

### BACKGROUND OF THE INVENTION

During difficult economic times, transaction account holders that have lost their jobs find it difficult or impossible to pay for at least a portion of their transaction charges. These transaction account holders often have many transaction accounts with amounts owing, along with other bills, so the transaction account holders are forced to choose between the various transaction accounts to remit a payment and the accounts to let become delinquent. Such delinquencies often cause transaction account issuers to spend a large amount of time and resources sending out notices, contacting account holders, negotiating alternative payment plans and potentially incurring write offs. Due to increasing regulations, it is also difficult for account issuers (or their representatives) to contact delinquent account holders. A strong need exists for a system and method to impact an account holder's ability and willingness to remit a payment for a particular transaction account.

### SUMMARY OF THE INVENTION

The present disclosure includes a system, method and/or computer program product for providing a career assistance program. In one embodiment, the system may include identifying a qualifying transaction account, providing access to the career assistance program to a qualifying transaction account holder, and annotating the identified qualifying transaction account associated with a qualifying transaction account holder with an indicator of participation in the career assistance program. The identified qualifying transaction account may be determined to meet a predetermined criteria. The career assistance program may include career counseling and career placement advice.

### BRIEF DESCRIPTION OF THE DRAWINGS

A more complete understanding of the present invention may be derived by referring to the detailed description and claims when considered in connection with the Figures, wherein like references refer to similar elements throughout the Figures, and:

FIG. 1 is a flow chart illustrating an exemplary method of offering services to a transaction account holder; and

FIG. 2 is a block diagram illustrating a detailed view of exemplary major system components for an automated system for offering services to transaction account holders.

### DETAILED DESCRIPTION OF EXEMPLARY EMBODIMENTS

The present system and method enables a transaction account issuer to match qualifying account holders with career assistance services. Career assistance services often expedite the process of networking, accessing job opportunities, increasing the number of interviews and obtaining employment offers. Career assistance services may include assistance with establishing clear goals, defining personal visions, developing personal marketing, networking skills, interviewing skills, connecting to real job leads and active professional networks, and providing access to tools and expert advice on how to approach a job opportunity in the current environment. This may include providing an open forum for establishing communication between job providers and job seekers. Career assistance may take the form of, for example, a web portal with hundreds of job leads, along with information on resumes, cover letters, networking, job searching, personality tests, industry profiles, current events related to a particular job or field, salary ranges, job descriptions, and company profiles. Live webinars or other instructional materials may be available on hundreds of topics including entrepreneurship, interview practice sessions networking practice sessions, certification training, and targeting jobs in specific industry sectors.

The system not only provides such career services to positively impact account holders' ability and willingness to remit a payment, but it also encourages and provides a compelling reason for account holders to remit a partial or full payment to a particular account issuer. The system also promotes significant goodwill and long-term dedication, by providing a significant service to an account holder during a difficult time. Such goodwill may reduce attrition and increase spending by account holders. Account holders may also have a compelling reason to contact the account issuer, which is particularly important when the issuer is not allowed to, or unable to, contact the account holder. By providing career assistance services to hundreds of qualifying account holders, an account issuer can still profit from the system, even if only one of the account holders remit a payment out of over 300 account holders. In one embodiment, the system may be at least partially provided by a third party partner, such as a third party provider of career services.

The system may include various computers, communications, interfaces, networking components, web pages and forms (as set forth below in more detail) to acquire information from users and/or databases to determine if the user is a qualifying account holder. The system may interface with historical transaction databases, credit bureaus, third party databases, accounts receivable databases, credit databases and/or profile databases to analyze a user's payment history, credit history and amounts owing. The system may consider any of the factors discussed herein to determine if the account holder is a qualifying account holder.

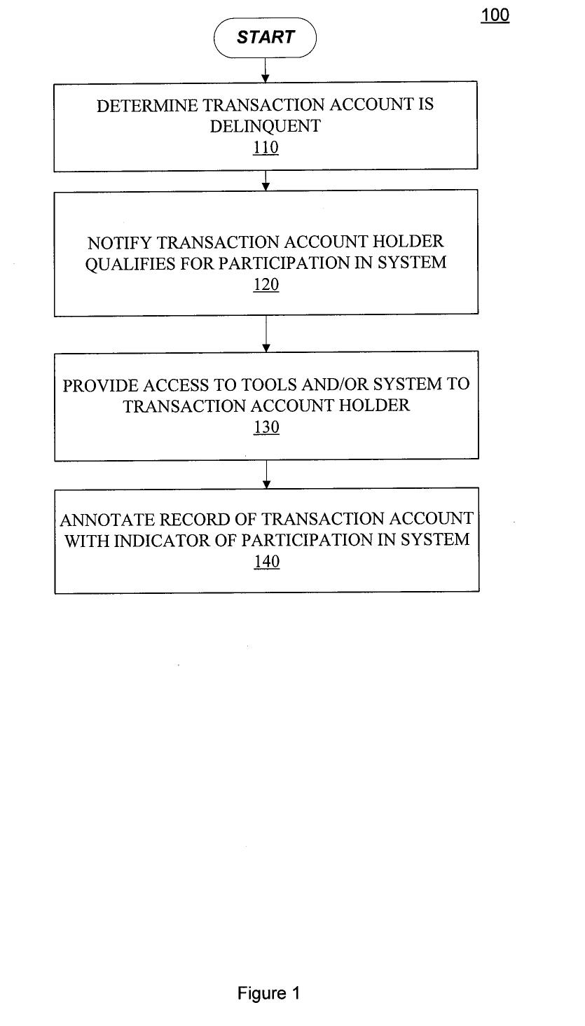

For example, and with reference to FIG. 1, if the system determines that the account holder is delinquent on payments to an account issuer (step 110), and/or at risk for the amounts due on the account to be written off by the account issuer, the system may notify and/or contact the account holder (via any communication means discussed herein) that the account holder qualifies for participation in the system (step 120). The system may then provide the account holder with information about the system and an access code, token or other rights to access certain career services or other services via a point of sale device, kiosk, web portal, webpage or in-person (step 130). The system may track participation in the system. The system may also place certain special credits or points onto the account holder's account, such that the credits or points can only be used for certain career services or only with certain career service vendors. The system may also flag the account holder's account, such that the flag automatically changes, adds or removes certain requirements, restrictions, benefits and/or limitations on the account, as set forth herein.

For instance, the system may increase the amount of and/or redemption rate of certain special credits or points on the account holder's account due to pre-selected activities of the user. These pre-selected activities may include having a preselected payment status on the transaction account, or communicating with the transaction account issuer regarding an associated transaction account. In an embodiment, the system may send a message to the account issuer to similarly adjust the account. The system may annotate the transaction account with a status indicator indicating participation in the system (step 140).

“Qualifying account holders”, as used herein, may include any individual, group, charity, entity, software and/or hardware that is a user, customer, member, rights holder and/or the like. Qualifying account holders may include all (or any subset of) account holders associated with a particular issuer, account holders with a certain type of account, primary account holders, subsidiary account holders, relatives of account holders, responsible parties of account holders, parties impacted by the account and/or the like. Qualifying account holders may also include a subset of users that are behind in payments for a certain time period, users that are at risk of having their past due accounts written off, users that are behind on a certain number of payments, users that are owing over or under a certain dollar amount, users that are account holders for a certain period of time, users having a debt for a certain length of time, users that made efforts to pay down the debt, subsequently spend or not spend a certain amount on a transaction account and/or the like. Qualifying account holders may also include a subset of users who are in need of career services, such as due to unemployment, and underemployment. Qualifying account holders may also include a subset of users who have a historical balance above a pre-selected threshold and/or have historical revolving balance above a pre-selected threshold. A qualifying account holder may also be any user that performs certain positive behaviors. Various examples of positive behaviors and awarding a user for a positive behavior may be found in U.S. Ser. No. 12/546,448 entitled “System and Method for Determining Consumer Incentives Based Upon Positive Consumer Behavior” filed on Aug. 24, 2009, which is hereby incorporated by reference in its entirety.

The system may provide certain types of career services, time periods for accessing career services and/or certain subsets of services for any qualifying account holder. The system may provide such career services based determining an amount of debt, length of debt, efforts to pay down the debt, length of time the account holder participated in the system, subsequent spend on a transaction account and/or the like. Such factors may relate to a particular account, may be based on a group of accounts associated with an issuer account, may be based on multiple accounts across many account issuers and/or may be based upon a variety of debt related accounts.

In one embodiment, at least a portion or all of the career assistance services may be offered free of charge for qualifying account holders. Certain additional services may be offered for a fee or in exchange for loyalty points. The system may only accept payment for the additional career services using an account from the account issuer which is providing the career assistance services. The system may only accept loyalty points associated with the account issuer which is providing the career assistance services. In an embodiment, the system may accept other types of loyalty points and may include a point conversion ratio. The system may permit the conversion module configured to convert loyalty points to currency as payment on a transaction account balance.

The system may also award loyalty points for using certain career services, and/or award additional loyalty points or loyalty points of a special designation alone or in addition to loyalty points for purchases on the transaction account. In one embodiment, the points may be awarded during the time the user is eligible for using the career services. For example, while the user is unemployed and looking for work, the system may award two times the typical amount of reward points to the user for purchases associated with the transaction account. In this way, the system enables an unemployed user to have a larger amount of loyalty points to obtain more rewards and to use to offset amounts due to the account issuer. For additional examples of systems for converting loyalty points to currency to pay down debt, that can be incorporated into the various embodiments of the present system, see for example, U.S. Ser. No. 09/834,478 titled “A System And Method For Using Loyalty Points” filed on Apr.13, 2001, which is hereby incorporated by reference in its entirety.

In various embodiments, the career assistance services may be combined with other services or rewards. For example, the career assistance services may be combined with access (e.g., exclusive) to early job postings, access to job postings of the account issuer, loyalty points, membership rewards points, prizes, rewards, gifts, packages, opportunities, adventure trips, entertainment, meetings with special people, special access passes, sporting events, cultural events, discounts on classifications of items, discounts on specific items, discounts on specific vendors, discounts within a defined geographical area, discounts within a consortium of merchants, and/or the like. For example, users who qualify for career services or perform certain positive behaviors within one geographic location, may obtain an award of loyalty points, where the loyalty points must be redeemed in a second geographic location, a subset of locations or without restrictions. Similarly, the loyalty points may be earned in one geographic location, a subset of locations or without restrictions, and then redeemed only in a specific geographic location. The geographic area information may be associated with the consumer, merchant, processing system and/or any other part of the overall system. The system may also facilitate the earning and redemption of points based upon product and/or service type. The system may also incorporate a conversion module which may convert the value of the loyalty points or value of the products/services based on the geographic area exchange rates.

The system includes facilitating earning loyalty points based on use or purchase of the career services and/or purchases using the transaction account, wherein the loyalty points are associated with a geographic area, and the method includes: receiving purchase data; determining a geographic area related to the purchase data; determining an amount of geographic area loyalty points based on the geographic area information and purchase data; and updating the loyalty account with the geographic area loyalty points. Receiving purchase data may include: receiving and storing manufacturer item identifiers; receiving and processing a consumer ID; receiving and processing purchase data, wherein the purchase data comprises a retailer item identifier; associating at least two of consumer ID, purchase data, and a manufacturer item identifier; and performing an analysis that is dependent upon the step of associating.

The system also facilitates redeeming loyalty points for the purchase of career services or for the use of paying at least a portion of transaction account charges, wherein the loyalty points are associated with a geographic area, by maintaining a database for storing geographic area loyalty points in a loyalty account corresponding to a user; receiving a request related to a requested geographic redemption area to redeem an amount of the geographic area loyalty points; determining if the requested geographic redemption area is associated with the geographic area loyalty points; and, adjusting the loyalty account based upon the amount of geographic area loyalty points.

The invention further includes redeeming the geographic area loyalty points for career services or account charges in a pre-determined geographic area. The determination of loyalty points or a geographic area may be accomplished by using at least one of: zip codes, retailer identification codes, retailer item identifier, store identifier, warranty data, service establishment codes, SKU codes, UPC manufacturer codes, consumer ID, retailer ID, manufacturer ID, purchaser profile, consumer enrollment data, retailer loyalty identifier, consumer account, aggregate consumer account, consumer profile, supplementary member profile, and third party provider information. Calculating the geographic area loyalty points may include using at least one of a formula, ratio, percentage, consumer level, global positioning system information, point level, retailer level, manufacturer level, and reward level. The method may be implemented by an interactive, online computer system and may further include informing a consumer of the loyalty points in real-time at a point-of-sale, a suggestive sale in a geographic area, pooling, gifting and transferring the geographic area loyalty points or receiving purchase data includes receiving consumer data from a dual use transaction card. More details regarding geographic systems and loyalty point systems which may be incorporated into various embodiments of the present invention are disclosed in U.S. patent application Ser. No. 10/708,570 entitled “Geographic Loyalty System And Method” and filed on Mar. 11, 2004; U.S. Pat. No. 7,613,629 entitled “System And Method For The Transfer Of Loyalty Points” filed on Nov. 26, 2002, U.S. Pat. No. 7,398,225 entitled “System And Method For Networked Loyalty Program” filed on Apr. 17, 2001; and, U.S. Pat. No. 7,398,226 entitled “System And Method For Networked Loyalty Program” filed on Nov. 6, 2001, which are hereby incorporated by reference in their entirety.

Systems and methods of rewarding participation in the career services system include a savings program which creates discounts on transactions at specific, program-enrolled merchants and/or based upon consumer spending. In one embodiment, the system enables a systematic and automatic discount to consumers when they use their transaction account for payment. As a reward for exhibiting a positive behavior such as using career services, paying a bill early or paying off the outstanding balance on a transaction account, a discount is systematically initiated simply by the consumer's use of the transaction account at an enrolled merchant. In other words, as part of an award for exhibiting a positive behavior, consumers receive consistent discounts off of the full (gross) amount of the transaction from each enrolled merchant. Such discounts may be reflected on the consumer's monthly statement, and may also accumulate and aggregate discounts or information related to the discounts. In addition, merchants may also receive statements detailing how and for what goods and/or services discounts were given to consumers. These statements may be physical statements mailed to the consumer and/or merchant or these statements may be electronic statements provided through an interface, such as via an Internet web site. This feature is advantageous to the issuer because it provides the ability to incentivize the consumer to exhibit a desired positive behavior by offering (and/or rewarding) better embedded card benefits. One benefit to merchants of this feature is the ability to drive additional business (e.g., incremental volume and new consumer acquisition), build brand equity through an innovative marketing program, and participate in an innovative marketing program at little or no additional technology expense. Consumers benefit from the automated discounting features it provides the ability to gain meaningful benefit and savings from merchant partners by simple use of the account, the ability to see immediate and tangible savings on monthly statement, guaranteed combinability of savings, and discounting on full amount of transaction (including any taxes or surcharges). Consumers also are able to see credits on their statement and receive accumulated, detailed and aggregate savings information. Additional details of such automatic discounting and consumer savings features are disclosed in U.S. application Ser. No. 11/161,906, entitled “Card Member Discount System And Method” and filed on Aug. 22, 2005, which is hereby incorporated by reference in its entirety.

“User” or “account holder” or “participant” may be used interchangeably and may include any person, entity, software and/or hardware that interacts with a system and/or participates in a process. For instance, user may perform tasks such as requesting, retrieving, receiving, updating, analyzing, entering and/or modifying career data. User may interface with Internet server via any communication protocol, device or method discussed herein, known in the art, or later developed.

“Entity” may include any user, individual, consumer, consumer, group, business, organization, government entity, transaction account issuer or processor (e.g., credit, charge, etc), merchant, consortium of merchants, consumer, account holder, charitable organization, software, hardware, and/or any other entity.

An “account”, “account number” or “consumer account” as used herein, may include any device, code (e.g., one or more of an authorization/access code, personal identification number (“PIN”), Internet code, other identification code, and/or the like), number, letter, symbol, digital certificate, smart chip, digital signal, analog signal, biometric or other identifier/indicia suitably configured to allow the consumer to access, interact with or communicate with the system. The account number may optionally be located on or associated with a rewards account, charge account, credit account, debit account, prepaid account, telephone card, embossed card, smart card, magnetic stripe card, bar code card, transponder, radio frequency card or an associated account. The system may include or interface with any of the foregoing accounts or devices, or a transponder and RFID reader in RF communication with the transponder (which may include a fob). Typical devices may include, for example, a key ring, tag, card, cell phone, wristwatch or any such form capable of being presented for interrogation. Moreover, the system, computing unit or device discussed herein may include a “pervasive computing device,” which may include a traditionally non-computerized device that is embedded with a computing unit. Examples may include watches, Internet enabled kitchen appliances, restaurant tables embedded with RF readers, wallets or purses with imbedded transponders, etc.

A “transaction account” may include any account that may be used to facilitate a financial transaction.

An “account issuer” or “financial institution” includes any entity that offers transaction account services to consumers. Although often referred to as a “financial institution,” the financial institution may represent any type of bank, lender or other type of account issuing institution, such as credit card companies, card sponsoring companies, or third party issuers under contract with financial institutions. It is further noted that other participants may be involved in some phases of the transaction, such as an intermediary settlement institution.

A “financial processor,” “payment network,” or “payment system” may include any entity which processes transactions, issues accounts, acquires financial information, settles accounts, conducts dispute resolution regarding accounts, and/or the like. As one of ordinary skill will recognize a financial account issuer may operate as, and provide the functions and services of a financial processor.

A “merchant” may include any person, entity, software and/or hardware that receives payment or other consideration. For example, a merchant may request payment for services rendered from a consumer who holds an account with a transaction account issuer.

An “item” may include any good or service. For example a merchant, may sell an item to a consumer and the consumer may provide payment for the item using a transaction account (e.g. a credit card).

“Firewall”, as used herein, may comprise any hardware and/or software suitably configured to protect VMAS 115 components from users of other networks. Firewall 120 may reside in varying configurations including stateful inspection, proxy based and packet filtering, among others. Firewall may be integrated as software within Internet server, any other system component, or may reside within another computing device or may take the form of a standalone hardware component.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., Windows NT, 95/98/2000, XP, Vista, OS2, UNIX, Linux, Solaris, MacOS, etc.) as well as various conventional support software and drivers typically associated with computers. A user may include any individual, business, entity, government organization, software and/or hardware that interact with a system. A web client includes any device (e.g., personal computer) which communicates via any network, for example such as those discussed herein. Such browser applications comprise Internet browsing software installed within a computing unit or a system to conduct online transactions and/or communications. These computing units or systems may take the form of a computer or set of computers, although other types of computing units or systems may be used, including laptops, notebooks, hand held computers, personal digital assistants, set-top boxes, workstations, computer-servers, main frame computers, mini-computers, PC servers, pervasive computers, network sets of computers, and/or the like. Practitioners will appreciate that a web client may or may not be in direct contact with an application server. For example, a web client may access the services of an application server through another server and/or hardware component, which may have a direct or indirect connection to an Internet server. For example, a web client may communicate with an application server via a load balancer. In an exemplary embodiment, access is through a network or the Internet through a commercially-available web-browser software package.

As those skilled in the art will appreciate, a web client includes an operating system (e.g., Windows NT, 95/98/2000/CE/Mobile, OS2, UNIX, Linux, Solaris, MacOS, PalmOS, etc.) as well as various conventional support software and drivers typically associated with computers. A web client may include any suitable personal computer, network computer, workstation, personal digital assistant, cellular phone, smart phone, minicomputer, mainframe or the like. A web client can be in a home or business environment with access to a network. In an exemplary embodiment, access is through a network or the Internet through a commercially available web-browser software package. A web client may implement security protocols such as Secure Sockets Layer (SSL) and Transport Layer Security (TLS). A web client may implement several application layer protocols including http, https, ftp, and sftp.

As used herein, the term “network” includes any electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., Palm Pilot®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, Dilip Naik, Internet Standards and Protocols (1998); Java 2 Complete, various authors, (Sybex 1999); Deborah Ray and Eric Ray, Mastering HTML 4.0 (1997); and Loshin, TCP/IP Clearly Explained (1997) and David Gourley and Brian Totty, HTTP, The Definitive Guide (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., Gilbert Held, Understanding Data Communications (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

As used herein, “transmit” may include sending electronic data from one system component to another over a network connection. Additionally, as used herein, “data” may include encompassing information such as commands, queries, files, data for storage, and the like in digital or any other form.

As used herein, “issue a debit”, “debit” or “debiting” refers to either causing the debiting of a stored value or prepaid card-type financial account, or causing the charging of a credit or charge card-type financial account, as applicable.

The system contemplates uses in association with web services, utility computing, pervasive and individualized computing, security and identity solutions, autonomic computing, commodity computing, mobility and wireless solutions, open source, biometrics, grid computing and/or mesh computing.

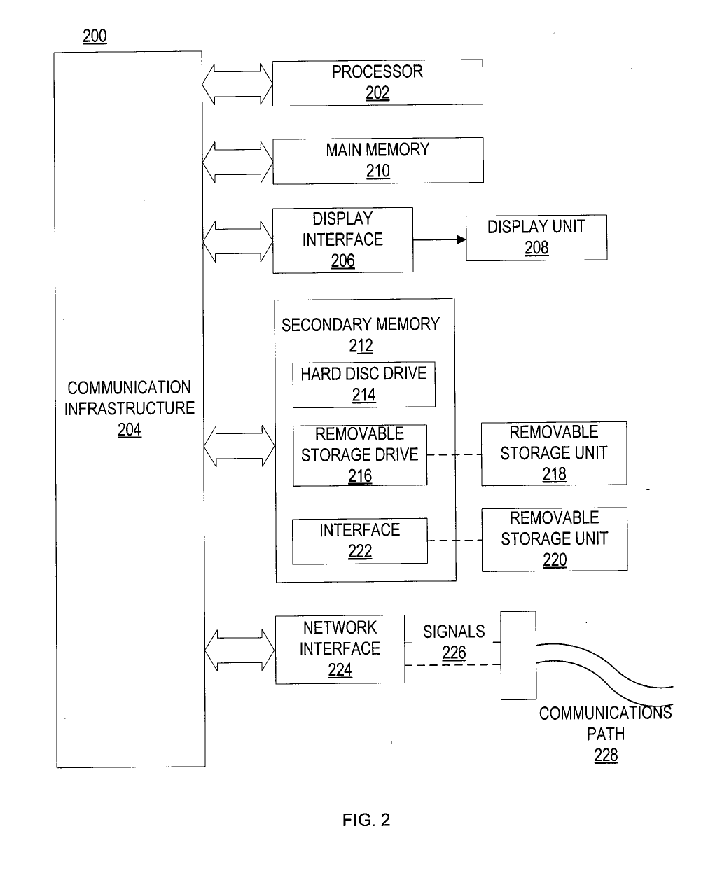

In one embodiment, the invention is directed toward one or more computer systems capable of carrying out the functionality described herein. An example of a computer system 200 is shown in FIG. 2.

Computer system 200 includes one or more processors 202. Processor 202 is connected to a communication infrastructure 204 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures. Computer system 200 can include a display interface 206 that forwards graphics, text, and other data from communication infrastructure 204 (or from a frame buffer not shown) for display on display unit 208.

Computer system 200 also includes a main memory 210, preferably random access memory (RAM), and may also include a secondary memory 212. Secondary memory 212 may include, for example, a hard disk drive 214 and/or a removable storage drive 216, representing a floppy disk drive, a magnetic tape drive, an optical disk drive, an information storage device, etc. Removable storage drive 216 reads from and/or writes to a removable storage unit 218. Removable storage unit 218 represents a floppy disk, a magnetic tape, an optical disk, etc. which is read by, and written to, by removable storage drive 216. Removable storage unit 218 includes a computer usable non-transitory storage medium having stored therein computer software and/or data.

In alternative embodiments, secondary memory 212 may include other similar devices for allowing computer programs or other instructions to be loaded into computer system 200. Such devices may include, for example, removable storage unit 218, 220 and an interface 222. Examples of secondary memory 212 include a program cartridge and cartridge interface, a removable memory chip (such as an erasable programmable read only memory (EPROM), and/or programmable read only memory (PROM)) with an associated socket, and removable storage unit 218, 220 and/or interface 222, which allow software and data to be transferred from removable storage unit 218, 220 to computer system 200.

Computer system 200 may also include a communications interface, such as a network interface 224. Network interface 224 allows software and data to be transferred between computer system 200 and an external device. Examples of communications interface may include a modem, a network interface (such as an Ethernet card), a communications port, a Personal Computer Memory Card International Association (PCMCIA) slot and card, etc. Software and data transferred via the communications interface are in the form of signals 226 which may be electronic, electromagnetic, optical or other signals capable of being received by the communications interface. These signals are provided to the communications interface via a communications path (e.g., channel) 228. Communications path 228 carries signals 226 and may be implemented using wire or cable, fiber optics, a telephone line, a cellular link, a radio frequency (RF) link, and/or other communications channels.

In this document, the terms “computer program medium” and “computer usable medium” are used to generally refer to media such as non-transitory removable storage drive such as a hard disk installed in hard disk drive 214, and signals 226. These computer program products provide software to computer system 200. The invention is directed to such computer program products.

Computer programs (also referred to as computer control logic) are stored in main memory 210 and/or secondary memory 212. Computer programs may also be received via the communications interface. Such computer programs, when executed, enable computer system 200 to perform the features, as discussed herein. In particular, the computer programs, when executed, enable processor 202 to perform the features. Accordingly, such computer programs represent controllers of computer system 200.

In an embodiment where the invention is implemented using software, the software may be stored in a computer program product and loaded into computer system 200 using removable storage drive 216, hard drive 214 or network interface 224. The control logic (software), when executed by processor 202, causes processor 202 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

Any databases discussed herein may include relational, hierarchical, graphical, or object-oriented structure and/or any other database configurations. Common database products that may be used to implement the databases include DB2 by IBM (Armonk, N.Y.), various database products available from Oracle Corporation (Redwood Shores, Calif.), Microsoft Access or Microsoft SQL Server by Microsoft Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In one exemplary embodiment, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the financial transaction instrument by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, in one exemplary embodiment, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a stand alone interaction device configured to add, delete, modify, or augment the data in accordance with the header or trailer. As such, in one embodiment, the header or trailer is not stored on the transaction device along with the associated issuer-owned data but instead the appropriate action may be taken by providing to the transaction instrument user at the stand alone device, the appropriate option for the action to be taken. The system may contemplate a data storage arrangement wherein the header or trailer, or header or trailer history, of the data is stored on the transaction instrument in relation to the appropriate data.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

The computing unit of the web client may be further equipped with an Internet browser connected to the Internet or an intranet using standard dial-up, cable, DSL or any other Internet protocol known in the art. Transactions originating at a web client may pass through a firewall in order to prevent unauthorized access from users of other networks. Further, additional firewalls may be deployed between the varying components to further enhance security.

Firewall may include any hardware and/or software suitably configured to protect components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within a web server or any other components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the Internet. A firewall may be integrated as software within an Internet server, any other application server components or may reside within another computing device or may take the form of a standalone hardware component.

The computers discussed herein may provide a suitable website or other Internet-based graphical user interface which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system. In one embodiment, the Apache web server is used in conjunction with a Linux operating system, a MySQL database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), AJAX (Asynchronous Javascript And XML), helper applications, plug-ins, and the like. A server may include a web service that receives a request from a web server, the request including a URL (http://yahoo.com/stockquotes/ge) and an IP address (123.56.789.234). The web server retrieves the appropriate web pages and sends the data or applications for the web pages to the IP address. Web services are applications that are capable of interacting with other applications over a communications means, such as the interne. Web services are typically based on standards or protocols such as XML, SOAP, AJAX, WSDL and UDDI. Web services methods are well known in the art, and are covered in many standard texts. See, e.g., Alex Nghiem, IT Web Services: A Roadmap for the Enterprise (2003), hereby incorporated by reference.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the Internet server. Middleware may be configured to process transactions between the various components of an application server and any number of internal or external systems for any of the purposes disclosed herein. WebSphere MQTM (formerly MQSeries) by IBM, Inc. (Armonk, N.Y.) is an example of a commercially available middleware product. An Enterprise Service Bus (“ESB”) application is another example of middleware.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, VBScript, Macromedia Cold Fusion, COBOL, Microsoft Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

An “account” or “account number”, as used herein, may include any device, code, number, letter, symbol, digital certificate, smart chip, digital signal, analog signal, biometric or other identifier/indicia suitably configured to allow the consumer to access, interact with or communicate with the system (e.g., one or more of an authorization/access code, personal identification number (PIN), Internet code, other identification code, and/or the like). The account number may optionally be located on or associated with a rewards card, charge card, credit card, debit card, prepaid card, telephone card, embossed card, smart card, magnetic stripe card, bar code card, transponder, radio frequency card or an associated account. The system may include or interface with any of the foregoing cards or devices, or a transponder and RFID reader in RF communication with the transponder (which may include a fob). Typical devices may include, for example, a key ring, tag, card, cell phone, wristwatch or any such form capable of being presented for interrogation. Moreover, the system, computing unit or device discussed herein may include a “pervasive computing device,” which may include a traditionally non-computerized device that is embedded with a computing unit. Examples can include watches, Internet enabled kitchen appliances, restaurant tables embedded with RF readers, wallets or purses with imbedded transponders, etc.

The account number may be distributed and stored in any form of plastic, electronic, magnetic, radio frequency, wireless, audio and/or optical device capable of transmitting or downloading data from itself to a second device. A customer account number may be, for example, a sixteen-digit credit card number, although each credit provider has its own numbering system, such as the fifteen-digit numbering system used by American Express. Each company's credit card numbers comply with that company's standardized format such that the company using a fifteen-digit format will generally use three-spaced sets of numbers, as represented by the number “0000 000000 00000”. The first five to seven digits are reserved for processing purposes and identify the issuing bank, card type, etc. In this example, the last (fifteenth) digit is used as a sum check for the fifteen digit number. The intermediary eight-to-eleven digits are used to uniquely identify the customer. A merchant account number may be, for example, any number or alpha-numeric characters that identify a particular merchant for purposes of card acceptance, account reconciliation, reporting, or the like.

As will be appreciated by one of ordinary skill in the art, the system may be embodied as a customization of an existing system, an add-on product, upgraded software, a stand alone system, a distributed system, a method, a data processing system, a device for data processing, and/or a computer program product. Accordingly, the system may take the form of an entirely software embodiment, an entirely hardware embodiment, or an embodiment combining aspects of both software and hardware. Furthermore, the system may take the form of a computer program product on a non-transitory computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the invention. Reference to an element in the singular is not intended to mean “one and only one” unless explicitly so stated, but rather “one or more.” Moreover, where a phrase similar to ‘at least one of A, B, and C’ or ‘at least one of A, B, and C’ is used in the claims or the specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the invention has been described as a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims.

1. A method comprising:
identifying, by a computer based system for providing a career assistance program, a qualifying transaction account, wherein the identified qualifying transaction account meets a predetermined criteria;
providing, by the computer based system, access to the career assistance program to a qualifying transaction account holder, wherein the career assistance program includes at least one of career counseling and career placement advice; and
annotating, by the computer based system, the identified qualifying transaction account associated with the qualifying transaction account holder with an indicator of participation in the career assistance program.

2. The method of claim 1, wherein the career counseling includes at least one of establishing career goals, defining a personal vision, developing personal marketing skills, developing networking skills, developing interviewing skills, connecting users to job leads, connecting users to professional networks, and providing a forum for establishing communication between job providers and job seekers.

3. The method of claim 1, wherein the career placement advice includes at least one of information associated with resumes, cover letters, networking, job search, personality tests, company profiles, industry profiles, current events, job descriptions, and salary ranges.

4. The method of claim 1, wherein the career counseling includes at least one of webinars, interview practice sessions, networking practice sessions, and certification training.

5. The method of claim 1, wherein the providing access is delivered via a web based portal.

6. The method of claim 1, further comprising contacting a qualifying transaction account holder regarding participation in the career assistance program.

7. The method of claim 1, wherein the qualifying criteria includes at least one of the user being a transaction account holder of a selected financial institution, the user being in need of career services, and the user having a balance above a predefined threshold.

8. The method of claim 1, wherein providing career counseling further comprises partnering with a third party provider of career services.

9. The method of claim 1, further comprising tracking user participation in the career assistance program.

10. The method of claim 1, further comprising associating career service credits with the qualifying transaction account for use in transactions associated with at least one of career services and career service vendors.

11. The method of claim 10, further comprising increasing the amount of career service credits based upon pre-selected activities of the user.

12. The method of claim 11, wherein the pre-selected activities include at least one of having a pre-selected payment status associated with the qualifying transaction account and communicating with a transaction account issuer of the qualifying transaction account.

13. The method of claim 10, further comprising awarding career service credits in association with awarding loyalty points for transactions involving the qualifying transaction account.

14. The method of claim 13, wherein at least one of career service credits and loyalty credits awarded are increased by a predetermined amount during participation in the career service program.

15. The method of claim 1, further comprising at least one of providing access to early job postings, access to job postings of the account issuer, loyalty points, membership rewards points, prizes, rewards, gifts, packages, opportunities, adventure trips, entertainment, meetings with special people, special access passes, sporting events, cultural events, discounts on classifications of items, discounts on specific items, discounts on specific vendors, discounts within a defined geographical area, and discounts within a consortium of merchants.

16. The method of claim 1, wherein identifying the qualifying transaction account includes interfacing with at least one of historical transaction databases, accounts receivable databases, credit databases, credit bureau, third party databases and profile databases.

17. The method of claim 1, further comprising incorporating a conversion module configured to convert loyalty points associated with the qualifying transaction account to currency to pay down debt while a user is associated with the career assistance program.

18. The method of claim 17, wherein the conversion of loyalty points to currency is at a higher rate than was associated with the qualifying transaction account prior to the qualifying transaction account being associated with the career assistance program.

19. A system comprising:
a tangible, non-transitory memory communicating with a processor for providing a career assistance program,
the tangible, non-transitory memory having instructions stored thereon that, in response to execution by the processor, cause the processor to perform operations comprising:
identifying, by the processor, a qualifying transaction account, wherein the identified qualifying transaction account meets a predetermined criteria;
providing, by the processor, access to the career assistance program to a qualifying transaction account holder, wherein the career assistance program includes at least one of career counseling and career placement advice; and
annotating, by the processor, the identified qualifying transaction account associated with the qualifying transaction account holder with an indicator of participation in the career assistance program.

20. An article of manufacture including a non-transitory, tangible computer readable medium having instructions stored thereon that, in response to execution by a computer-based system for providing a career assistance program, cause the computer-based system to perform operations comprising:
identifying, by the computer based system, a qualifying transaction account, wherein the identified qualifying transaction account meets a predetermined criteria;
providing, by the computer based system, access to the career assistance program to a qualifying transaction account holder, wherein the career assistance program includes at least one of career counseling and career placement advice; and
annotating, by the computer based system, the identified qualifying transaction account associated with the qualifying transaction account holder with an indicator of participation in the career assistance program.
